(19) United States
(12) Patent Application Publication
(10) Pub. No.: US 2005/0076652 A1
(43) Pub. Date: Apr. 14, 2005

(54) Method and apparatus for removing boiling liquid from a tank

(76) Inventor: Rudolf Erwin Berghoff, Wedel (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/950,664

(22) Filed: Sep. 28, 2004

(30) Foreign Application Priority Data
Oct. 10, 2003 (DE) 103 47 129.4
Feb. 12, 2004 (DE) 10 2004 006346.8

(51) Int. Cl. F17C 1/00; F17C 7/04; F17C 9/02

(52) U.S. Cl. 62/48.1; 62/50.2

(57) ABSTRACT

A method and apparatus are provided for removing a boiling liquid from a tank. The liquid is removed from the tank and, before the delivery to a consuming device is supplied to an intermediate receptacle in which the boiling liquid is subjected to a pressure reduction and subsequently to a pressure increase.

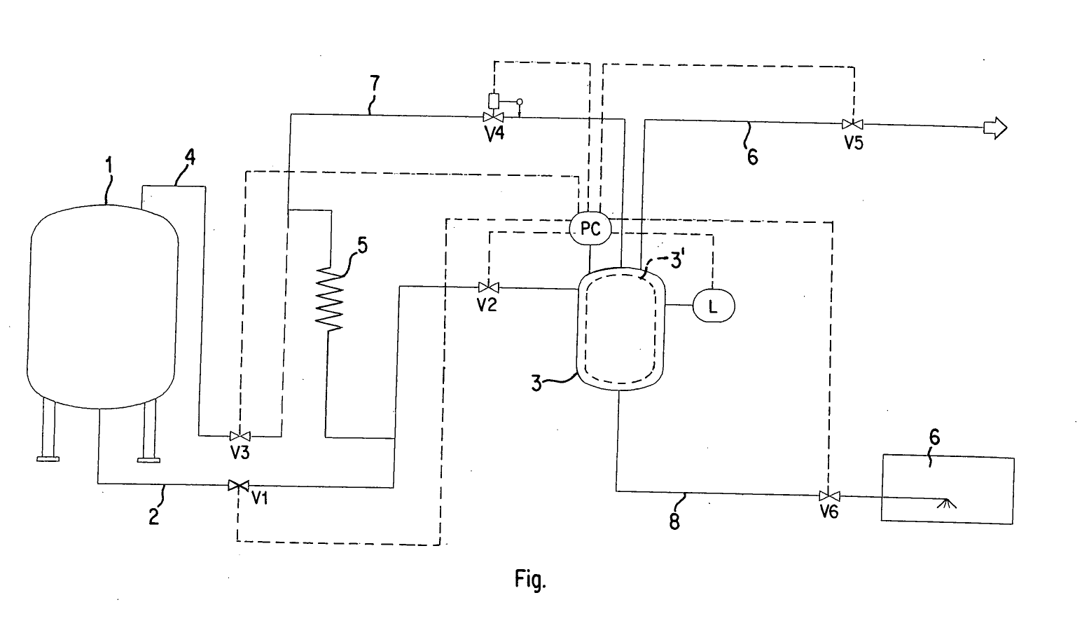

### BACKGROUND AND SUMMARY OF THE INVENTION

This application claims the priority of German Application No. 103 47 129.4 filed Oct. 10, 2003 and German Application No. 10 2004 006346.8 filed Feb. 12, 2004, the disclosures of which are expressly incorporated by reference herein.

The invention relates to a method of removing a boiling liquid from a tank. For removing boiling liquids (for example, liquefied gases) from a tank, normally the present tank pressure is used for generating a flow through nozzles or valves. Only rarely is the boiling liquid fed to a booster pump for generating a condition in which the liquid is supercooled. It is also known that the boiling liquid in an intermediate receptacle is acted upon by a higher pressure in order to produce a supercooled liquid in this manner. In some applications, a partial relaxation of the liquid takes place in an intermediate receptacle behind the tank. The liquid will then flow at a reduced pressure but not supercooled along to the application location.

It is an object of the invention to provide an improved method and apparatus for removing a boiling liquid from a tank.

This object is achieved according to certain preferred embodiments of the invention in that the liquid is removed from the tank and is guided to an intermediate receptacle before being delivered to a consuming device, in which intermediate receptacle the boiling liquid is subjected to a pressure decrease and then to a pressure increase.

After the removal of the desired quantity of boiling liquid, the pipe between the tank and the intermediate receptacle is advantageously closed. The intermediate receptacle is thus filled to a defined level.

The pressure decrease in the intermediate receptacle is preferably implemented by releasing gas from the head space of the intermediate receptacle.

Particularly preferably, the pressure increase in the intermediate receptacle is carried out by feeding gas from the tank.

According to an advantageous further development of certain preferred embodiments of the invention, the pressure increase in the intermediate receptacle is implemented by feeding liquid from the tank, the liquid being guided via a vaporizer.

Particularly advantageous according to certain preferred embodiments of the invention, the liquid is removed from the lower part of the tank.

The mass flow through nozzles, screens, valves, etc. reduced during the relaxation vaporization is to be increased by using a supercooled liquid. A relaxation vaporization in an outflow opening is to be prevented as completely as possible. Known systems also aim at providing a supercooled liquid, but do not prevent the occurrence of a relaxation vaporization to the extent desired here.

According to certain preferred embodiments of the invention, the boiling liquid is relaxed in a receptacle, if possible, to atmospheric pressure. Subsequently, the intermediate receptacle is pressurized. This pressurization takes place by the flowing-in of the same medium as the medium present in the intermediate receptacle and is removed from the same storage tank (preferably in a gaseous state, but it can also be in a liquid state). By means of suitable devices, the pressure may also be lowered here below the ambient pressure.

Other known methods utilize either a lowering of the pressure of the boiling liquid or a pressure increase but not a combination of the two. In the case of the method with the lowering of pressure, the relaxation usually does not take place to the ambient pressure (atmospheric pressure) but to a pressure higher than the ambient pressure. According to certain preferred embodiments of the invention, the pressurization of the intermediate receptacle takes place by means of the fluid from the storage tank, whereas external storage devices are used in the state of the art.

The invention as well as details of the invention will be explained in the following by means of an embodiment illustrated in the figure.

Other objects, advantages and novel features of the present invention will become apparent from the following detailed description of the invention when considered in conjunction with the accompanying drawings.

### BRIEF DESCRIPTION OF THE DRAWINGS

The single FIGURE illustrates an R&I flow chart of the arrangement according to the invention.

### DETAILED DESCRIPTION OF THE DRAWINGS

In a storage tank 1, the liquefied gas is stored at a pressure higher than the ambient pressure in the pertaining phase equilibrium. Liquid flows from the lower part of the tank 1 through tank pipe 2 into the intermediate receptacle 3 and fills the latter to a defined level. The flow from tank pipe 2 is then closed by closing valve V2. The gas is then released from the gas space of the intermediate receptacle 3 by opening valve V5 in pipe 6, and the pressure in the intermediate receptacle 3 is thereby lowered. The fluid in the intermediate receptacle 3 cools in this gas release process. A subsequent pressurization changes the fluid in the intermediate receptacle thermodynamically to a condition of a supercooled liquid.

The subsequent pressure increase in the intermediate receptacle 3 can take place directly by means of gas from the storage tank 1 or by means of liquid from the storage tank 1, which then becomes gaseous in a vaporizer 5. For this pressure increase step directly by gas from storage tank 1, valve V3 in pipe 4 is opened and valve V4 in pipe 7 is also opened, while valves V5 and V6 are closed. For the alternative with pressure increase step by means of liquid from the storage tank 1, valves V2, V3, V5, and V6 are closed and valves V1 and V4 are opened so the liquid from tank 1 flows through and is vaporized in vaporizer 5. The pressure increase should take place as closely as possible before the delivery of the liquid from the intermediate receptacle 3 by way of pipe 8 and valve V6 to an application location 6. The supercooling degree of the fluid in the intermediate receptacle can be controlled by way of the pressure level achieved during the pressure increase step.

The schematically depicted computerized control unit PC controls the sequence of valve openings and closings. A level sensor L provides an input to the control unit PC which represent the filling level of the intermediate receptacle.

Preferred embodiments of the invention have a number of additional advantages:

A relaxation vaporization during the flow out of nozzles, valves, screens, etc. can be avoided by providing supercooled liquid. A two-phase flow of liquid and gas does not occur, but a single-phase liquid flow is maintained. This is very advantageous for any application.

The mass flow through nozzles, valve, screens or the like can be drastically increased in comparison to a boiling liquid.

By controlling the pressure in the intermediate receptacle 3, a desired mass flow can be adjusted without having to make any changes (for example, larger/smaller, more/fewer nozzles) at the outflow elements (nozzles, valves, screens and the like).

By using the supercooled liquid generated according to the invention, the mass flow can be precisely apportioned.

The flow pressure loss in pipes, valves, nozzles and other components is clearly lower than when a two-phase flow is formed.

The mass flow rate of a single-phase flow can be precalculated significantly more precisely than the mass flow rate of a two-phase flow.

While the throughput is the same, a lower pressure can be achieved in the storage tank 1, which promotes a higher refrigeration energy in the stored liquid gas.

While the throughput is the same, a lower flow pressure can be achieved, whereby the jet velocity and turbulences are reduced to thereby permit a steady flow for the application 6.

A further development of certain preferred embodiments of the invention provides a second intermediate receptacle 3 (shown in schematically dashed lines) parallel to the receptacle 3. In the alternating operation, the two receptacles permit a continuous delivery of supercooled liquid. As a result, the invention is suitable for all applications in which a continuous supply of liquid gas and a precise process management are required. With only one intermediate receptacle 3, the invention is suitable for all applications in which a discontinuous supply (batch operation) of supercooled liquid is required.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Method of removing a boiling liquid from a tank, wherein the liquid is removed from the tank and, before delivery to a consuming device, is supplied to an intermediate receptacle in which the boiling liquid is subjected to a pressure reduction and subsequently to a pressure increase.

2. Method according to claim 1, wherein a pipe between the tank and the intermediate receptacle is closed after the removal of the desired quantity of boiling liquid.

3. Method according to claim 1, wherein the pressure reduction in the intermediate receptacle is implemented by releasing gas from a head space of the intermediate receptacle.

4. Method according to claim 2, wherein the pressure reduction in the intermediate receptacle is implemented by releasing gas from a head space of the intermediate receptacle.

5. Method according to claim 1, wherein the pressure increase in the intermediate receptacle is implemented by feeding gas from the tank.

6. Method according to claim 2, wherein the pressure increase in the intermediate receptacle is implemented by feeding gas from the tank.

7. Method according to claim 3, wherein the pressure increase in the intermediate receptacle is implemented by feeding gas from the tank.

8. Method according to claim 4, wherein the pressure increase in the intermediate receptacle is implemented by feeding gas from the tank.

9. Method according to claim 1, wherein the pressure increase in the intermediate receptacle is implemented by feeding liquid from the tank via a vaporizer to the intermediate receptacle.

10. Method according to claim 2, wherein the pressure increase in the intermediate receptacle is implemented by feeding liquid from the tank via a vaporizer to the intermediate receptacle.

11. Method according to claim 3, wherein the pressure increase in the intermediate receptacle is implemented by feeding liquid from the tank via a vaporizer to the intermediate receptacle.

12. Method according to claim 1, wherein the pressure increase in the intermediate receptacle is implemented by feeding liquid from the tank via a vaporizer to the intermediate receptacle.

13. Method according to claim 5, wherein the liquid is removed from the lower part of the tank.

14. Method according to claim 2, wherein the liquid is removed from the lower part of the tank.

15. Method according to claim 3, wherein the liquid is removed from the lower part of the tank.

16. Method according to claim 5, wherein the liquid is removed from the lower part of the tank.

17. Method according to claim 9, wherein the liquid is removed from the lower part of the tank.

18. A method for supplying boiling liquid from a tank to a consuming device, comprising the sequential steps:
feeding boiling liquid from the tank to an intermediate receptacle to thereby fill the intermediate receptacle to a predetermined level,
subjecting the boiling liquid in the intermediate receptacle to a pressure reduction,
subjecting the boiling liquid in the intermediate receptacle to a pressure increase, and
feeding the liquid from the intermediate receptacle to a consuming device.

19. Apparatus for supplying boiling liquid from a tank to a consuming device, comprising:
intermediate receptacle feeding means feeding boiling liquid from the tank to an intermediate receptacle to thereby fill the intermediate receptacle to a predetermined level,
means for subsequently subjecting the boiling liquid in the intermediate receptacle to a pressure reduction,
means for subsequently subjecting the boiling liquid in the intermediate receptacle to a pressure increase, and
consumer feeding means for feeding the liquid from the intermediate receptacle to a consuming device.

20. Apparatus according to claim 19, comprising a computerized control unit for controlling the feeding means and the means for subjecting the boiling liquid in the intermediate receptacle to said pressure reduction and said pressure increase.

21. Apparatus according to claim 19, comprising:
a plurality of intermediate receptacles disposed parallel to one another between the tank and the consuming device and operable to provide for continuous flow of boiling liquid from the tank to the consuming device.
